(19) United States
(12) Patent Application Publication
(10) Pub. No.: US 2005/0113518 A1
(43) Pub. Date: May 26, 2005

(54) Process for the functionalization of polyolefins

(75) Inventors: Tiziano Tanaglia, Bologna (IT); Aroldo Biggi, San Donato Milanese-Milan (IT); Orsola Casaburo, San Donato Milanese-Milan (IT); Lisa Biggi, San Donato Milanese-Milan (IT); Francesco Masi, Sant'Angelo Lodigiano-Lodi (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: POLIMERI EUROPA S.p.A, Brindisi (IT)

(21) Appl. No.: 10/507,218

(22) PCT Filed: Mar. 12, 2003
(86) PCT No.: PCT/EP03/02636

(30) Foreign Application Priority Data
Mar. 30, 2002 (IT) M12002A000583

(51) Int. Cl. C08F 8/00

(52) U.S. Cl. 525/192

(57) ABSTRACT

Process for the preparation of functionalized polyolefins, which comprises treatment under shear conditions of said polyolefins with an unsaturated monomer containing polar groups in the presence of at least one hydroperoxide as radicalic initiator. The process allows the grafting of unsaturated monomers without the formation of cross-linked polymeric material and without modifying the molecular weight distribution.

The present invention relates to a process for the functionalization of polyolefins by treatment, under shear conditions, of said polyolefins with an unsaturated monomer containing polar groups in the presence of at least one hydroperoxide as radicalic initiator.

Polyolefins are non-polar products which have a poor affinity with traditional materials such as for example, glass and metals in general, and are incompatible with polar synthetic polymers such as polyesters and polyamides. Furthermore, polyolefins have a limited adhesion strength to these materials.

The preparation of composite or laminated materials starting from polyolefins as such and from the above traditional materials, consequently creates considerable difficulties.

These difficulties have given rise, in relatively recent times, to intense research activities aimed at obtaining polyolefins with improved surface properties.

Reactions relating to the functionalization of polyolefins by the grafting of polar monomers using radicalic reactions promoted by peroxides, have been described in literature.

For example patent U.S. Pat. No. 4,147,746 describes the modification reaction of polyethylene with derivatives of maleic, itaconic and citraconic acid in the presence of peroxides.

When the modification reaction of polyolefins, however, must ensure that the physico-chemical and rheological characteristics of the starting polyolefin are kept as unvaried as possible, the use of peroxides as radicalic initiators can be unsatisfactory.

It is known in fact that peroxides favour the cross-linking of polyolefins, in particular EPDM, in competition with the grafting reaction and produce undesired increases in the molecular weight and a broadening of the molecular weight distribution.

Reactions relating to the functionalization of polyolefins in which hydroperoxide is indicated among the possible initiators, have been described in literature (UP-55016022, GB-1168959).

Under the conditions in which the functionalization takes place in the above patents, however, low shear and a temperature higher than the decomposition value, the hydroperoxide behaves in exactly the same way as any radicalic initiator.

It has now been found that by using hydroperoxides under shear conditions in the grafting reaction of polyolefins with an unsaturated monomer, it is possible to obtain functionalized polyolefins effectively reducing the cross-linking phenomena of the substrate. There are consequently no uncontrolled increases in the molecular weight or the formation of microgels and branchings which can influence the processability of the end-product.

In accordance with this, the present invention relates to a process for the functionalization of polyolefins which comprises the treatment of polyolefins under shear conditions with an unsaturated monomer containing polar groups in the presence of at least one hydroperoxide as radicalic initiator.

The polyolefins can be used in the process of the present invention are selected from:
copolymers of ethylene with α-olefins;
copolymers of propylene with α-olefins;
ethylene/propylene copolymers (EPM) with a molar propylene content ranging from 16% to 50%, preferably from 20% to 45%, and a number molecular weight (Mw) ranging from 10,000 to 200,000;
ethylene/propylene/non-conjugated diolefin (EPDM) ter-polymers.

Typical examples of non-conjugated diolefins are 1,4-hexadiene, 1,5-heptadiene, 1,6-octadiene, 1,4-cyclohexadiene, 5-methylene-2-norbornene, 5-ethylidene-2-norbornene. These EPDM usually have a molar ethylene content ranging from 40 to 85%, preferably from 40 to 70%; from 15 to 70%, preferably from 30 to 60% molar, of propylene; from 0.5 to 20% molar, preferably from 1 to 15%, even more preferably from 2 to 10% molar of non-conjugated diene.

The molecular weights Mw of the EPDM are within the range of 75,000 to 450,000, preferably from 100,000 to 180,000 and the non-conjugated diene is preferably 5-ethylidene-2-norbornene;
thermoplastic elastomers deriving from butadiene and/or isoprene and styrene block copolymers, hydrogenated and non-hydrogenated.

The polyolefins which can be used for the purposes of the present invention can be prepared according to any of the methods known in the art.

With respect to the hydroperoxide (or mixture of hydroperoxides) which can be used for the purposes of the present invention, any hydroperoxide can be used, which, at the process temperature, does not undergo a significant decomposition. In other terms, the hydroperoxide preferably has a half-life which is not shorter than the process time, even more preferably not less than 10 times the process time.

Typical examples of hydroperoxides are cumene hydroperoxide, hydrogen peroxide, t-butyl hydroperoxide, 2,5-dihydroperoxy-2,5-dimethyl hexane.

Polar unsaturated monomers which can be used in the process of the present invention are selected from derivatives of unsaturated carboxylic acids such as esters, amides, acids, metallic salts of acrylic acid, fumaric acid, itaconic acid, citraconic acid and maleic acid, maleic anhydride, esters of vinyl alcohol, vinyl silane derivatives, vinyl imidazole derivatives, vinyl oxazole derivatives, vinyl pyridine derivatives.

Maleic anhydride and its derivatives are preferably used.

The hydroperoxide is added to the polymeric material as such or dissolved in a suitable solvent.

The concentration of hydroperoxide with respect to the polyolefins ranges from 0.1 to 20% by weight, preferably from 0.2 to 10% by weight, even more preferably from 0.5% to 5% by weight.

The quantity of monomer used in the present invention generally ranges from 0.1 to 10, preferably from 0.4 to 1.5% with respect to the polyolefins.

The process of the present invention is carried out under high shear conditions, usually higher than 100 sec¹, preferably higher than 1000 sec¹.

The process is carried out at a temperature ranging from 80 to 250° C., preferably from 140 to 200° C. for a time ranging from 1 to 1800 seconds, preferably from 30 to 600 seconds.

The above process can be effected in a reactor suitable for the purpose such as, for example, a batch mixer or an extruder.

The process of the present invention is preferably carried out in an extruder, even more preferably in a twin-screw extruder.

The process of the present invention is effected without the introduction of oxygen and can be carried out either batchwise or in continuous. When operating batchwise, the single components are added in a suitable reactor together or in reasonable portions, in the presence or absence of a solvent, preferably without a solvent.

When operating in continuous, the reagents are added continuously, at a suitable feeding rate, to a reactor (or a reactor zone) thermostat-regulated at the desired temperature.

At the end of the above process, if necessary for the subsequent application, antioxidants, light and heat stabilizers, nucleating agents, organic and inorganic dyes or other additives selected from those known in the art, can be added.

The polyolefins modified according to the process of the present invention can be used in various fields, particularly in the production of coating materials and laminates.

The following examples are provided for a better understanding of the present invention.

### EXAMPLES

All the examples were carried out using the same polymer, a commercial EPDM ENICHEM DUTRAL^{R} ter 4033 having 25% by weight of propylene, 4.9% by weight of ethylidene-norbornene (ENB)−MFI (L)=2.4 g/10 minutes.

The t-butyl hydroperoxide (TBHP) used was supplied by Akzo Nobel at 70% in aqueous solution (trade-name Trigonox^{R} AW70).

The dicumyl peroxide (DCP) was supplied by Elf-Atochem carried at 40% on EPR (trade-name PeroximonR DC40).

Diethyl maleate (DEM) was used as modifying monomer. The chemical modification was determined by means of IR analysis of the product washed in acetone. The presence and intensity of the band at about 1740 cm⁻¹ is evidence of grafting.

An internal quantitative method based on the height of the band was used to avoid interaction with other bands. The value obtained, calculated on the basis of calibrations on ester groups different from the bound DEM, does not exactly correspond to the concentration of grafted DEM, but must be used as a comparison.

### EXAMPLE 1

A 70 cc mixing chamber is charged with 40 g of EPDM polymer DUTRAL^{R} Ter 4033, 1% of t-butyl hydroperoxide and 3.3% of diethyl maleate (DEM), thermostat-regulated at 105° C. (external) and kept under mixing at 50 revs/minute. A temperature of 130° C. is reached at equilibrium.

The mixture is left to plasticize for 60 seconds, and the rate of the rotors is then suddenly increased to 200 revs/minute; the temperature rises (maximum temperature of the molten product 190° C.) and the torque pair measured with the instrument is slowly lowered.

After 2 minutes of mastication, the experiment is interrupted and the product recovered.

The results of the analyses are indicated in Table 1.

### Example 2

### Comparative

The mixing chamber of Example 1 is charged with 40 grams of polymer DUTRAL Ter 4033 and 3.3% of DEM, thermostat-regulated at 105° C. (external) and kept under mixing at 50 revs/minute. A temperature of 130° C. is reached at equilibrium.

The mixture is left to plasticize for 60 seconds, and the rate of the rotors is then suddenly increased to 200 revs/minute; the temperature rises (maximum temperature of the molten product 180° C.) and the torque pair measured with the instrument is slowly lowered.

After 2 minutes of mastication, the experiment is interrupted and the product recovered.

The results of the analyses are indicated in Table 1.

### Example 3

### Comparative

The mixing chamber of Example 1 is charged with 40 grams of polymer DUTRAL Ter 4033, 0.3% of dicumyl peroxide (DCP) and 3.3% of DEM, thermostat-regulated at 105° C. (external) and kept under mixing at 50 revs/minute. A temperature of 130° C. is reached at equilibrium.

The mixture is left to plasticize for 60 seconds, and the rate of the rotors is then suddenly increased to 200 revs/minute; the temperature rises (maximum temperature of the molten product 195° C.) and the torque pair measured with the instrument is slowly lowered.

After 2 minutes of mastication, the experiment is interrupted and the product recovered.

The results of the analyses are indicated in Table 1.

### Example 4

### Comparative

The mixing chamber of Example 1 is charged with 40 grams of polymer DUTRAL Ter 4033, 1% of t-butyl hydroperoxide, at a temperature of about 160° C. (external) and kept under mixing at 60 revs/minute. The temperature is then gradually increased to 220° C. After 4 minutes, the product is recovered.

The results of the analyses are indicated in Table 1.

TABLE 1

| | | Arbitrary grafting unit |
|---|---|---|
| Example | Solubility in ODCB | (IR) |
| 1 | complete | 0.70 |
| 2 | complete | 0.03 |
| 3 | insoluble | n.d. (*) |
| 4 | 40% | n.d. |

(*) not determined.

From Table 1 it can be seen that the combined use of hydroperoxide and shear conditions (Example 1) produces unexpected advantageous effects with respect to the prior art.

It is possible in fact to use polymers critical for peroxide treatment with hydroperoxide, without observing cross-linking and obtaining grafting reactions with respect to polar monomers such as DEM.

1. A process for the functionalisation of polyolefins selected from:
ethylene/propylene copolymers (EPM) with a molar propylene content ranging from 16% to 50%, and an Mw ranging from 10,000 to 200,000;
ethylene/propylene/non-conjugated diolefin (EPDM) terpolymers with a molar ethylene content ranging from 40 to 85%, from 15 to 70% of propylene and 2 to 10% molar of non-conjugated diene, the molecular weights Mw of the EPDM being within the range from 75,000 to 450,000;
which comprise the treatment under shear conditions higher than 100 sec⁻¹, with a polar unsaturated monomer selected from maleic anhydride and its derivatives, in the presence of at least one hydroperoxide as radicalic initiator, the concentration of hydroperoxide with respect to the polyolefins ranging from 0.1 to 20% by weight.

2. The process according to claim 1, wherein the shear conditions are higher than 1000 sec¹.

4. The process according to claim 3, wherein the ethylene/propylene (EPM) copolymers have a molar propylene content ranging from 20% to 45%.

5. The process according to claim 3, wherein the ethylene/propylene/non-conjugated diolefin (EPDM) ter-polymers have a molar ethylene content ranging from 40 to 70%, from 30 to 60% of propylene and from 0.5 to 20% of non-conjugated diene.

6. The process according to claim 5, wherein the ethylene/propylene/non-conjugated diolefin (EPDM) ter-polymers have a molar content of non-conjugated diene ranging from 1 to 15% molar.

7. The process according to claim 6, wherein the ethylene/propylene/non-conjugated diolefin (EPDM) ter-polymers have a molar content of non-conjugated diene ranging from 2 to 10% molar.

8. The process according to claim 5, wherein the ethylene/propylene/non-conjugated diolefin (EPDM) ter-polymers have a molecular weight Mw ranging from 100,000 to 180,000.

9. The process according to claim 3, wherein the non-conjugated diolefins are selected from 1,4-hexadiene, 1,5-heptadiene, 1,6-octadiene, 1,4-cyclohexadiene, 5-methylene-2-norbornene, 5-ethylidene-2-norbornene.

10. The process according to claim 9 wherein the non-conjugated diolefin is 5-ethylidene-2-norbornene.

11. The process according to claim 1, wherein the hydroperoxide is selected from cumene hydroperoxide, hydrogen peroxide, t-butyl hydroperoxide, 2,5-dihydroperoxy-2,5-dimethyl hexane

12. The process according to claim 1, wherein the concentration of hydroperoxide with respect to the polyolefins ranges from 0.1 to 20% by weight.

13. The process according to claim 12, wherein the concentration of hydroperoxide with respect to the polyolefins ranges from 0.2 to 10% by weight.

14. The process according to claim 13, wherein the concentration of hydroperoxide with respect to the polyolefins ranges from 0.5% to 5% by weight.

15. The process according to claim 1, wherein the polar unsaturated monomers are selected from unsaturated carboxylic acids such as esters, amides, acids, metallic salts of acrylic acid, fumaric aid, itaconic acid, citraconic acid and maleic acid, maleic anhydride, esters of vinyl alcohol, vinyl silane derivatives, vinyl imidazoles, vinyl oxazole derivatives, vinyl pyridine derivatives.

16. The process according to claim 15, wherein the polar unsaturated monomers are selected from maleic anhydride and its derivates.

17. The process according to claim 1, wherein the quantity of polar unsaturated monomers ranges from 0.1 to 10% with respect to the polyolefins.

18. The process according to claim 17, wherein the quantity of polar unsaturated monomers ranges from 0.4 to 1.5% with respect to the polyolefins.

19. The process according to claim 1, carried out at a temperature ranging from 80 to 250° C., for a time ranging from 1 to 1800 seconds.

20. The process according to claim 19, wherein the temperature ranges from 140 to 200° C. and the time ranges from 30 to 600 seconds.
